(19) United States
(12) Patent Application Publication
(10) Pub. No.: US 2026/0309071 A1
(43) Pub. Date: Oct. 8, 2026

(54) TWO-CYCLE ENGINE WITH SCAVAGING PASSAGE

(71) Applicant: MARUYAMA MFG. CO., INC., Tokyo (JP)

(72) Inventor: Masanori NOGUCHI, Tokyo (JP)

(21) Appl. No.: 19/530,341

(22) Filed: Feb. 5, 2026

(30) Foreign Application Priority Data
Apr. 2, 2025 (JP) 2025-061106

(51) Int. Cl. F02B 25/16; F02B 75/02

(52) U.S. Cl. CPC F02B 25/16; F02B 2075/025

(57) ABSTRACT

A cylinder of an engine is provided with an intake port configured to introduce air into a cylinder bore, an exhaust port configured to discharge exhaust gas in the cylinder bore, and a scavenging passage configured to send a mixture to a region closer to a combustion chamber than a piston in the cylinder bore in a scavenging stroke. A scavenging inlet and a scavenging outlet of the scavenging passage open on a bore inner peripheral surface, respectively. In the scavenging stroke, a first region closer to the combustion chamber than a piston head and a second region closer to a crank chamber than the piston head in the cylinder bore communicate with each other via the scavenging passage.

### CROSS-REFERENCE TO RELATED APPLICATIONS

This application is based upon and claims the benefit of priority from Japanese Patent Application No. 2025-061106, filed on Apr. 2, 2025, the entire contents of which are incorporated herein by reference.

### BACKGROUND

The present disclosure relates to a two-cycle engine and an engine working machine.

Portable engine working machines such as brush cutters and chainsaws often use two-cycle engines as power sources. Two-cycle engines have a scavenging passage communicating with a crank chamber and a combustion chamber. As a piston reciprocates in a cylinder bore, a mixture pre-compressed in the crank chamber is introduced into the combustion chamber through the scavenging passage, and scavenging is performed by this mixture.

Generally, "blow-by of mixture (fresh air) may occur in two-cycle engines." That is, the scavenging mixture introduced into the combustion chamber is discharged as it is from an exhaust port of the cylinder. For example, International Publication No. 2021/177010 describes introducing air into the combustion chamber from the scavenging passage first to participate in scavenging, thereby reducing the blow-by of the mixture.

### SUMMARY

An example two-cycle engine includes: a cylinder including a cylinder bore and a combustion chamber connected to one end of the cylinder bore in an axial direction of the cylinder bore; a crankcase disposed on the cylinder and provided with a crank chamber connected to an opposite end of the cylinder bore in the axial direction; a piston configured to reciprocate in the cylinder bore; and an injector configured to inject fuel into the crank chamber. The cylinder is provided with: an intake port communicating with the cylinder bore and configured to introduce air into the cylinder bore; an exhaust port communicating with the cylinder bore and configured to discharge exhaust gas from the cylinder bore; and a scavenging passage configured to send a mixture to a first region closer to the combustion chamber than a piston head of the piston in the cylinder bore in a scavenging stroke. A scavenging outlet and a scavenging inlet of the scavenging passage open on a bore inner peripheral surface of the cylinder bore, respectively. In the scavenging stroke, the scavenging outlet is located closer to the combustion chamber than a piston head of the piston on the bore inner peripheral surface, the scavenging inlet is located closer to the crank chamber than the piston head on the bore inner peripheral surface, and the first region and a second region closer to the crank chamber than the piston head in the cylinder bore communicate with each other via the scavenging passage.

### BRIEF DESCRIPTION OF THE DRAWINGS

FIG. 1 is a block diagram showing an example engine working machine equipped with an engine.

FIG. 2 is a longitudinal sectional view of the engine provided in the engine working machine, in an intake stroke where a piston is located at a top dead center.

FIG. 3 is a sectional view taken along line III-III of FIG. 2.

FIG. 4 is a schematic perspective view for explaining a relationship between the piston and a scavenging passage when the piston is located at the top dead center.

FIG. 5 is a longitudinal sectional view of the engine in a scavenging stroke where the piston is located at a bottom dead center.

FIG. 6 is a schematic perspective view for explaining a relationship between the piston and the scavenging passage when the piston is located at the bottom dead center.

FIG. 7A is a front view of the piston.

FIG. 7B is a perspective view of the piston.

FIG. 7C is a side view of the piston.

FIG. 8A is a schematic front view showing a state of each part when the piston is moving toward the top dead center.

FIG. 8B is a schematic front view showing a state of each part when the piston is located at the top dead center.

FIG. 9A is a schematic front view showing a state of each part when the piston is moving toward the bottom dead center.

FIG. 9B is a schematic front view showing a state of each part when the piston is located at the bottom dead center.

### DETAILED DESCRIPTION

In the following description, with reference to the drawings, the same reference numbers are assigned to the same components or to similar components having the same function, and overlapping description is omitted.

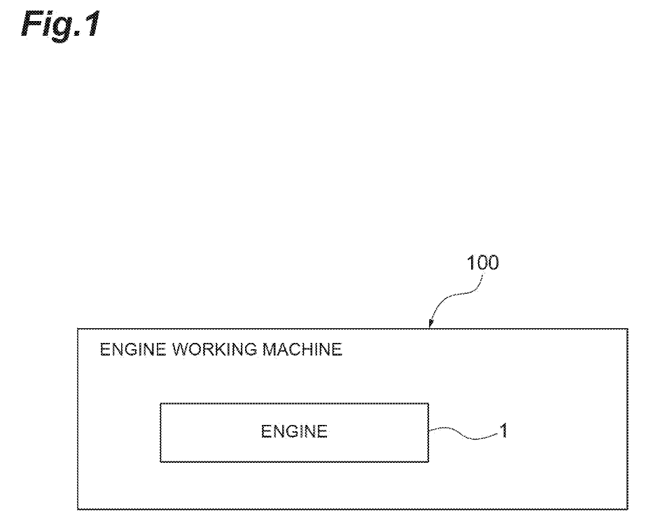

As shown in FIG. 1, an engine working machine 100 includes an engine (two-cycle engine) 1 as a power source. The engine working machine 100 may be, for example, a portable working machine such as a brush cutter or a chainsaw. The type of work performed by the engine working machine 100 is not limited as long as the engine working machine 100 includes the engine 1 as a power source.

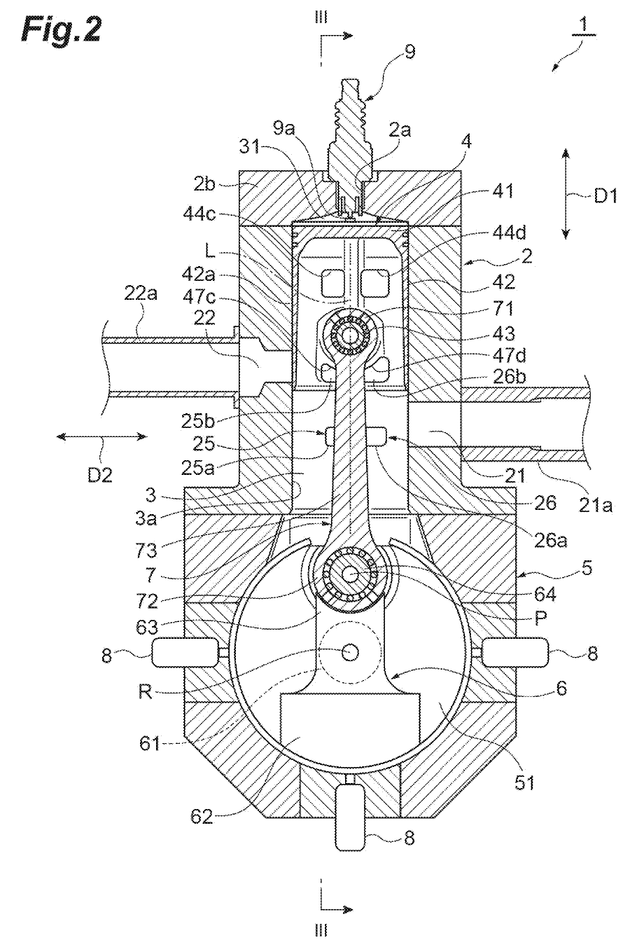

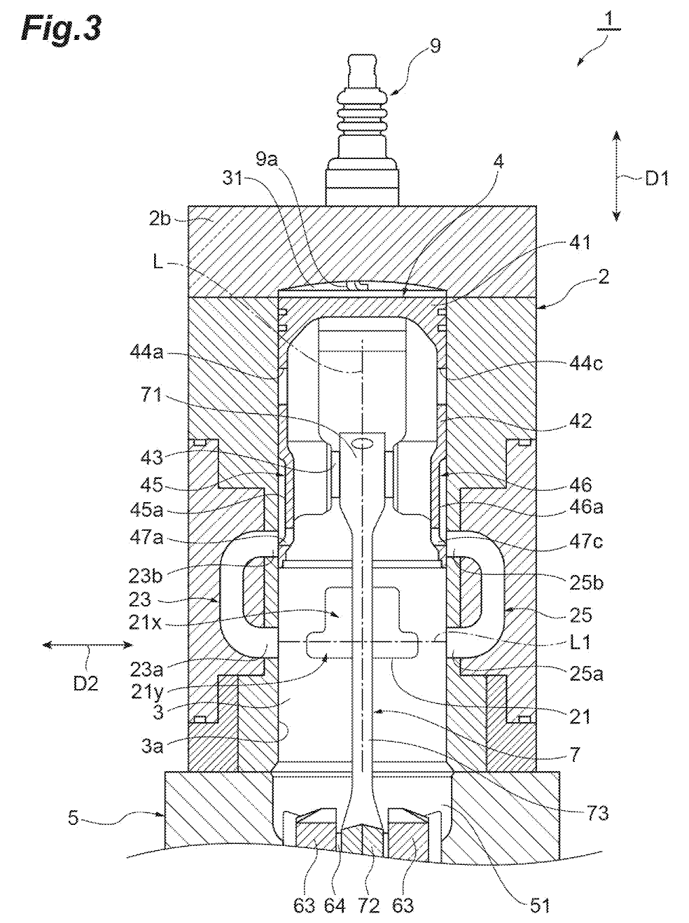

As shown in FIGS. 2 and 3, the engine 1 is, for example, a two-cycle engine adopting a Schnuerle method as a scavenging method. The engine 1 include a cylinder 2, a piston 4 configured to reciprocate in a cylinder bore 3 formed in the cylinder 2, a crankcase 5, a crank mechanism 6, a connecting rod, an injector 8, and a spark plug 9.

In this specification, the term "vertical" is defined based on an orientation in which the cylinder 2 is set upright so that the cylinder bore 3 extends in the vertical direction, with a combustion chamber 31 formed in the cylinder 2 at the top. "Upper" corresponds to one side in the direction of an axis L (an axial direction D1) of the cylinder bore 3, and "lower" corresponds to the other side in the direction of the axis L. That is, the vertical direction here is the same as the direction of the axis L. The engine 1 may be arranged upright so that the cylinder bore 3 extends in the vertical direction, or may be arranged sideways so that the cylinder bore 3 extends in the horizontal direction. The installation orientation of the engine 1 is not limited.

The crankcase 5 is disposed below the cylinder 2 (at the other end of the axis L) and forms a crank chamber 51 connected to the lower end of the cylinder bore 3 (the end in the other direction of the axis L). The crank mechanism 6 is disposed in the crank chamber 51. The injector 8 is configured to inject fuel into the crank chamber 51.

The connecting rod 7 connects a piston pin 43 provided in the piston 4 and a crank pin 64 of the crank mechanism 6. Therefore, the connecting rod 7 connects a crankshaft 61 of the crank mechanism 6 disposed in the crank chamber 51 and the piston 4. The piston 4 is disposed in the cylinder bore 3 and is capable of reciprocating along the vertical direction (direction of the axis L) between the combustion chamber 31 provided in an upper portion of the cylinder bore 3 and the crank chamber 51.

The cylinder bore 3, the combustion chamber 31, an intake port 21, and an exhaust port 22 are formed in the cylinder 2. The cylinder bore 3 has a cylindrical bore inner peripheral surface 3a and extends within the cylinder 2 along the direction of the axis L. The cylinder bore 3 is open at the end of the bottom dead center (the lower part in FIG. 2) of the cylinder bore 3 and communicates with the crank chamber 51. The combustion chamber 31 is formed at an end of the cylinder bore 3 corresponding to the top dead center (one end in the direction of the axis L (here, upper end)) and has a recessed shape. Thus, the combustion chamber 31 is connected to one end of the cylinder bore 3 in the direction of the axis L. A discharge electrode 9a of the spark plug 9 attached to the upper portion (an end wall 2b) of the cylinder 2 is disposed inside the combustion chamber 31. A spark plug attachment hole 2a to which the spark plug 9 is attached is provided in the vicinity of the combustion chamber 31 of the cylinder 2.

The intake port 21 is configured to introduce air into the cylinder bore 3 via an intake pipe 21a. For example, a throttle valve is provided in the intake pipe 21a, and an air cleaner or the like is provided upstream of the throttle valve. The degree of opening of the throttle valve is operated by an operator using the engine working machine 100. The exhaust port 22 is configured to discharge exhaust gas in the combustion chamber 31 generated by burning the mixture to the outside via an exhaust pipe 22a. For example, a muffler or the like for silencing exhaust noise is provided in the exhaust pipe 22a.

The intake port 21 and the exhaust port 22 communicate with the cylinder bore 3, respectively. In the vertical direction, the exhaust port 22 is disposed closer to the end of the top dead center (upper end) than the intake port 21. The intake port 21 and the exhaust port 22 are disposed opposite each other in the radial direction of the cylinder bore 3. The intake port 21 and the exhaust port 22 are disposed shifted from each other by approximately 180° in the circumferential direction of the cylinder bore 3.

The crank mechanism 6 has a crankshaft 61, a pair of crank webs 62 connected to the crankshaft 61, and a pair of connecting portions 63 provided on the opposite side of the crank webs 62 in the radial direction. The connecting rod 7 has a small end portion 71 disposed in the cylinder bore 3, a large end portion 72 disposed in the crank chamber 51, and a rod body 73 connecting the small end portion 71 and the large end portion 72. The piston pin 43 is inserted through the small end portion 71 of the connecting rod 7, and the small end portion 71 is rotatably connected to the piston 4 via the piston pin 43. The crank pin 64 is inserted through the large end portion 72 of the connecting rod 7, and the large end portion 72 is rotatably connected to the connecting portion 63 of the crank mechanism 6 via the crank pin 64. When the crankshaft 61 rotates around a rotation center R, a connection center P of the connecting rod 7 with respect to the connecting portion 63 moves circularly around the rotation center R of the crankshaft 61.

The injector 8 is configured to inject fuel into the crank chamber 51. The engine 1 may be provided with three injectors 8. The injectors 8 are attached to the crankcase 5. The fuel injection tip of the injector 8 faces the crank chamber 51. However, the number of injectors 8 is not limited.

As shown in FIGS. 2 to 6, the cylinder 2 is provided with scavenging passages 23, 24, 25, and 26. The scavenging passages 23 to 26 are configured to send a mixture to a region closer to the combustion chamber 31 than the piston 4 in the cylinder bore 3 in the scavenging stroke. The scavenging passages 23 and the scavenging passages 25 may be arranged with the cylinder bore 3 interposed therebetween. The scavenging passages 24 and the scavenging passages 26 may be arranged with the cylinder bore 3 interposed therebetween. Each of the scavenging passages 23 to 26 has the same configuration and function. Therefore, hereinafter, the scavenging passage 23 among the scavenging passages 23 to 26 will be described as a representative. The scavenging passages 24 to 26 also have the same configuration and function as the scavenging passage 23 described as a representative.

The scavenging passage 23 may be a hole provided in the cylinder 2. The scavenging passage 23 has a scavenging inlet 23a and a scavenging outlet 23b. The scavenging inlet 23a constitutes the upstream end in the flow direction of the mixture flowing through the scavenging passage 23 in the scavenging stroke. The scavenging outlet 23b constitutes the downstream end in the flow direction of the mixture flowing through the scavenging passage 23 in the scavenging stroke.

The scavenging inlet 23a and the scavenging outlet 23b each open on the bore inner peripheral surface 3a of the cylinder bore 3. On the bore inner peripheral surface 3a of the cylinder bore 3, the scavenging outlet 23b is provided at a position closer to the combustion chamber 31 than the scavenging inlet 23a. The intake port 21 and the scavenging inlet 23a of the scavenging passage 23 are provided at positions where at least parts thereof overlap each other in the direction of the axis L (see FIG. 3).

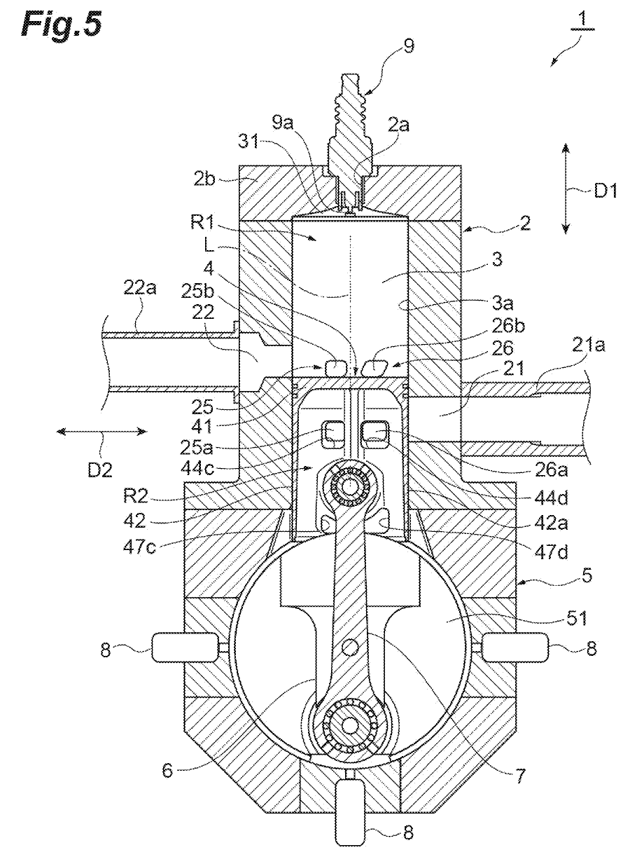

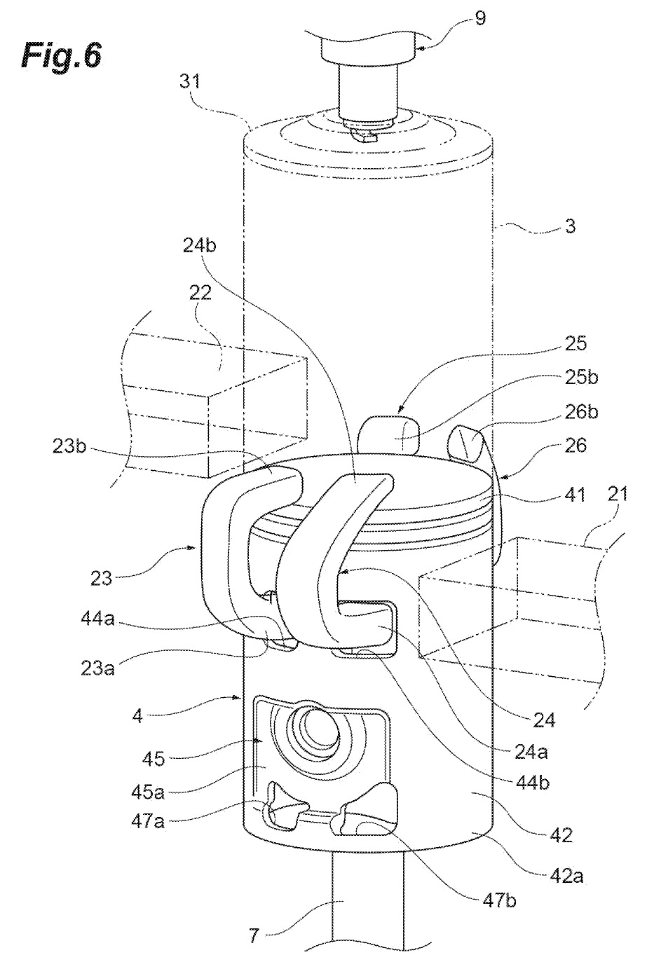

Particularly as shown in FIGS. 5 and 6, in the scavenging stroke of the engine 1, the scavenging outlet 23b is located closer to the combustion chamber 31 than the piston head 41 of the piston 4 on the bore inner peripheral surface 3a. In the scavenging stroke of the engine 1, the scavenging inlet 23a is located closer to the crank chamber 51 than the piston head 41 on the bore inner peripheral surface 3a. Therefore, in the scavenging stroke of the engine 1, a first region R1 closer to the combustion chamber 31 than the piston head 41 in the cylinder bore 3 and a second region R2 closer to the crank chamber 51 than the piston head 41 in the cylinder bore 3 communicate with each other via the scavenging passage 23.

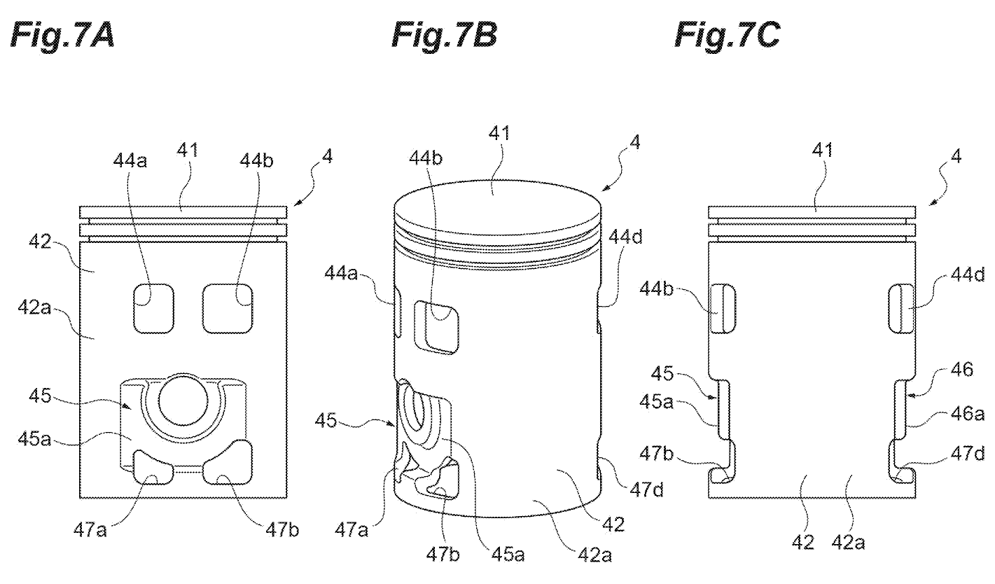

As shown in FIGS. 7A to 7C, the piston 4 has a piston head 41 and a piston skirt 42 extending from an outer edge portion of the piston head 41. The piston skirt 42 is provided with a piston scavenging hole 44a. As shown in FIG. 6, the piston scavenging hole 44a communicates with the scavenging inlet 23a of the scavenging passage 23 in the scavenging stroke. The communication between the scavenging inlet 23a of the scavenging passage 23 and the piston scavenging hole 44a provided in the piston 4 means that at least parts of the scavenging inlet 23a and the piston scavenging hole 44a face each other in the radial direction of the cylinder bore 3 (direction orthogonal to the axis L). Therefore, in the scavenging stroke, the scavenging passage 23 communicates with the space inside the piston 4 (the second region R2) via the scavenging inlet 23a and the piston scavenging hole 44a provided in the piston 4. The space inside the piston 4 (the second region R2) is a space inside the piston skirt 42 and is also a space surrounded by the piston head 41 and the piston skirt 42.

The piston scavenging hole 44a is provided in the piston skirt 42 at a position closer to the piston head 41 than the piston pin 43 connecting the piston 4 and the connecting rod 7.

As shown in FIGS. 5 and 6, similarly to the scavenging inlet 23a and the scavenging outlet 23b included in the scavenging passage 23, the scavenging passage 24 has a scavenging inlet 24a and a scavenging outlet 24b, the scavenging passage 25 has a scavenging inlet 25a and a scavenging outlet 25b, and the scavenging passage 26 has a scavenging inlet 26a and a scavenging outlet 26b.

As shown in FIGS. 7A to 7C, the piston 4 is provided with a piston scavenging hole 44b, a piston scavenging hole 44c (see FIG. 5), and a piston scavenging hole 44d, similarly to the piston scavenging hole 44a. The piston scavenging holes 44a and the piston scavenging holes 44c are arranged opposite each other in the radial direction of the piston skirt 42 (cylinder bore 3). The piston scavenging holes 44b and the piston scavenging holes 44d are arranged opposite each other in the radial direction of the piston skirt 42 (cylinder bore 3). As shown in FIGS. 5 and 6, the piston scavenging hole 44b communicates with the scavenging inlet 24a of the scavenging passage 24 in the scavenging stroke. The piston scavenging hole 44c communicates with the scavenging inlet 25a of the scavenging passage 25 in the scavenging stroke. The piston scavenging hole 44d communicates with the scavenging inlet 26a of the scavenging passage 26 in the scavenging stroke.

A piston recess 45 and a piston recess 46 (see FIGS. 3 and 7C) are provided on an outer surface 42a of the piston skirt 42. The piston recess 45 and the piston recess 46 are provided so as to be oriented in opposite directions from each other in the radial direction of the piston skirt 42 (cylinder bore 3). The piston skirt 42 is further provided with a piston intake hole 47a, a piston intake hole 47b, a piston intake hole 47c (see FIG. 5), and a piston intake hole 47d. The piston intake holes 47a and the piston intake holes 47c are arranged opposite each other in the radial direction of the piston skirt 42 (cylinder bore 3). The piston intake holes 47b and the piston intake holes 47d are arranged opposite each other in the radial direction of the piston skirt 42 (cylinder bore 3).

The piston intake holes 47a and 47b are provided in a part of a bottom portion 45a of the piston recess 45. The piston intake holes 47a and 47b are provided in the vicinity of a lower edge portion (portion closer to the crank chamber 51) of the piston skirt 42 in the bottom portion 45a of the piston recess 45. Similarly, the piston intake holes 47c and 47d are provided in the vicinity of a lower edge portion (portion closer to the crank chamber 51) of the piston skirt 42 in a bottom portion 46a of the piston recess 46.

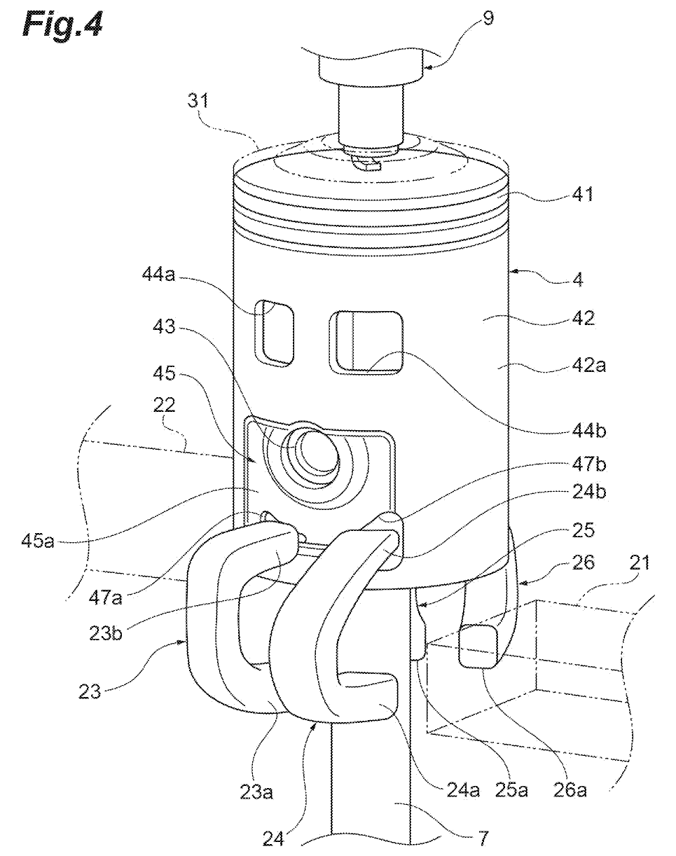

As shown in FIG. 4, the piston recess 45 faces the scavenging outlet 23b of the scavenging passage 23 and the scavenging outlet 24b of the scavenging passage 24 in the intake stroke of introducing air from the intake port 21 into the cylinder bore 3. In a state where the scavenging outlet 23b of the scavenging passage 23 and the scavenging outlet 24b of the scavenging passage 24 face the piston recess 45, the scavenging outlet 23b and the scavenging outlet 24b are not blocked by the outer surface 42a of the piston skirt 42. That is, the scavenging outlet 23b and the scavenging outlet 24b are open.

In a state where the scavenging outlet 23b of the scavenging passage 23 and the bottom portion 45a of the piston recess 45 face each other, the scavenging passage 23 communicates with the space inside the piston 4 via the piston recess 45 and the piston intake holes 47a and 47b provided in the piston recess 45. In a state where the scavenging outlet 24b of the scavenging passage 24 and the bottom portion 45a of the piston recess 45 face each other, the scavenging passage 24 communicates with the space inside the piston 4 via the piston recess 45 and the piston intake holes 47a and 47b provided in the piston recess 45.

The piston intake hole 47a provided in the bottom portion 45a of the piston recess 45 faces the scavenging outlet 23b of the scavenging passage 23 and communicates with the scavenging outlet 23b in the intake stroke. The piston intake hole 47b provided in the bottom portion 45a of the piston recess 45 faces the scavenging outlet 24b of the scavenging passage 24 and communicates with the scavenging outlet 24b in the intake stroke. The piston intake holes 47a and 47b face the scavenging outlets 23b and 24b, respectively, at a timing immediately before the intake stroke ends (see FIG. 4).

In a state where the scavenging outlet 23b of the scavenging passage 23 and the piston intake hole 47a provided in the piston recess 45 face each other, the scavenging passage 23 communicates with the space inside the piston 4 via the piston intake hole 47a. In a state where the scavenging outlet 24b of the scavenging passage 24 and the piston intake hole 47b provided in the piston recess 45 face each other, the scavenging passage 24 communicates with the space inside the piston 4 via the piston intake hole 47b.

Similarly, as shown in FIGS. 2 and 3, the piston recess 46 faces the scavenging outlet 25b of the scavenging passage 25 and the scavenging outlet 26b of the scavenging passage 26 in the intake stroke in which the piston 4 moves from the bottom dead center toward the top dead center to introduce air from the intake port 21 into the second region R2. In a state where the scavenging outlet 25b of the scavenging passage 25 and the scavenging outlet 26b of the scavenging passage 26 face the piston recess 46, the scavenging outlet 25b and the scavenging outlet 26b are not blocked by the outer surface 42a of the piston skirt 42. That is, the scavenging outlet 25b and the scavenging outlet 26b are open.

The configuration around the piston recess 46 is similar to the that around the piston recess 45. In a state where the scavenging outlet 25b of the scavenging passage 25 and the piston recess 46 face each other, the scavenging passage 25 communicates with the space inside the piston 4 via the piston recess 46 and the piston intake holes 47c and 47d provided in the piston recess 46. In a state where the scavenging outlet 26b of the scavenging passage 26 and the piston recess 46 face each other, the scavenging passage 26 communicates with the space inside the piston 4 via the piston recess 46 and the piston intake holes 47c and 47d provided in the piston recess 46.

The piston intake hole 47c provided in the bottom portion 46a of the piston recess 46 faces the scavenging outlet 25b of the scavenging passage 25 and communicates with the scavenging outlet 25b in the intake stroke. The piston intake hole 47d provided in the bottom portion 46a of the piston recess 46 faces the scavenging outlet 26b of the scavenging passage 26 and communicates with the scavenging outlet 26b in the intake stroke. The piston intake holes 47c and 47d face the scavenging outlets 25b and 26b, respectively, at a timing immediately before the intake stroke ends.

In a state where the scavenging outlet 25b of the scavenging passage 25 and the piston intake hole 47c provided in the piston recess 46 face each other, the scavenging passage 25 communicates with the space inside the piston 4 via the piston intake hole 47c. In a state where the scavenging outlet 26b of the scavenging passage 26 and the piston intake hole 47d provided in the piston recess 46 face each other, the scavenging passage 26 communicates with the space inside the piston 4 via the piston intake hole 47d.

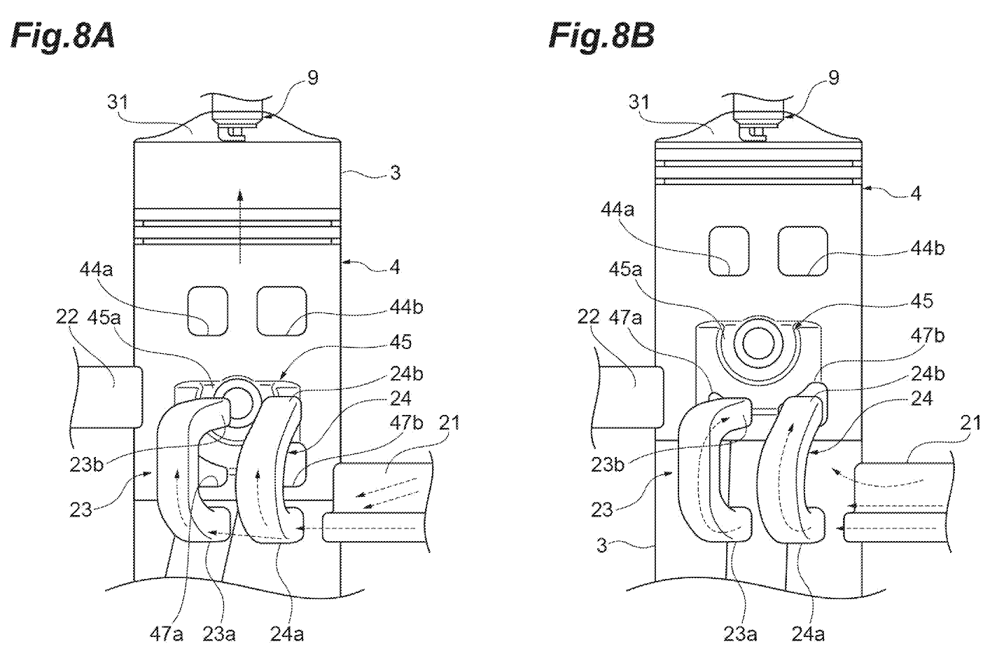

Subsequently, the operation of the engine 1 will be described. As shown in FIG. 8A, along with the movement of the piston 4 from the bottom dead center to the top dead center, the exhaust port 22 is closed by the piston 4, and the intake port 21 opens. Therefore, air is introduced from the intake port 21 into the second region R2, and air is also introduced into the crank chamber 51 via the second region R2. Along with this movement of the piston 4, the mixture supplied to the combustion chamber 31 in the previous scavenging stroke is compressed. Then, as shown in FIG. 8B, when the piston 4 reaches the vicinity of the top dead center, the mixture in the combustion chamber 31 is ignited by the spark plug 9, and the mixture combusts.

The injector 8 injects fuel into the crank chamber 51 at a timing when the piston 4 reaches the vicinity of the top dead center. However, the timing of injecting fuel from the injector 8 into the crank chamber 51 is not limited to the timing when the piston 4 reaches the vicinity of the top dead center. The injector 8 may inject fuel by the timing when the mixture is sent to the first region R1 in the scavenging stroke. From the viewpoint of ensuring a state where the concentration of fuel in the second region R2 is low and the concentration of fuel on the crank chamber 51 is high when performing the scavenging stroke, the fuel injection timing may be set immediately before the scavenging stroke as much as possible.

As shown in FIGS. 8A and 8B, in a state where the scavenging outlet 23b of the scavenging passage 23 faces the piston recess 45 in the intake stroke, the scavenging outlet 23b is not blocked by the outer surface 42a of the piston 4 and is open. The scavenging inlet 23a of the scavenging passage 23 is located closer to the crank chamber 51 than the lower end portion of the piston 4 and is open. As the piston 4 moves toward the top dead center in the intake stroke, the inner space of the piston 4 becomes negative pressure (pressure decreases). For this reason, the air in the scavenging passage 23 is sucked into the piston 4 from the scavenging outlet 23b via the piston recess 45 and the piston intake hole 47a. Therefore, the mixture remaining in the scavenging passage 23 in the previous scavenging stroke is sucked into the piston 4. Then, the scavenging passage 23 is filled with the air introduced from the intake port 21 via the scavenging inlet 23a. In the scavenging passages 24 to 26 as well, similarly to the scavenging passage 23, the mixtures remaining inside the scavenging passages 24 to 26 are sucked, and each of the inner space of the scavenging passages 24 to 26 is filled with the air introduced from the intake port 21.

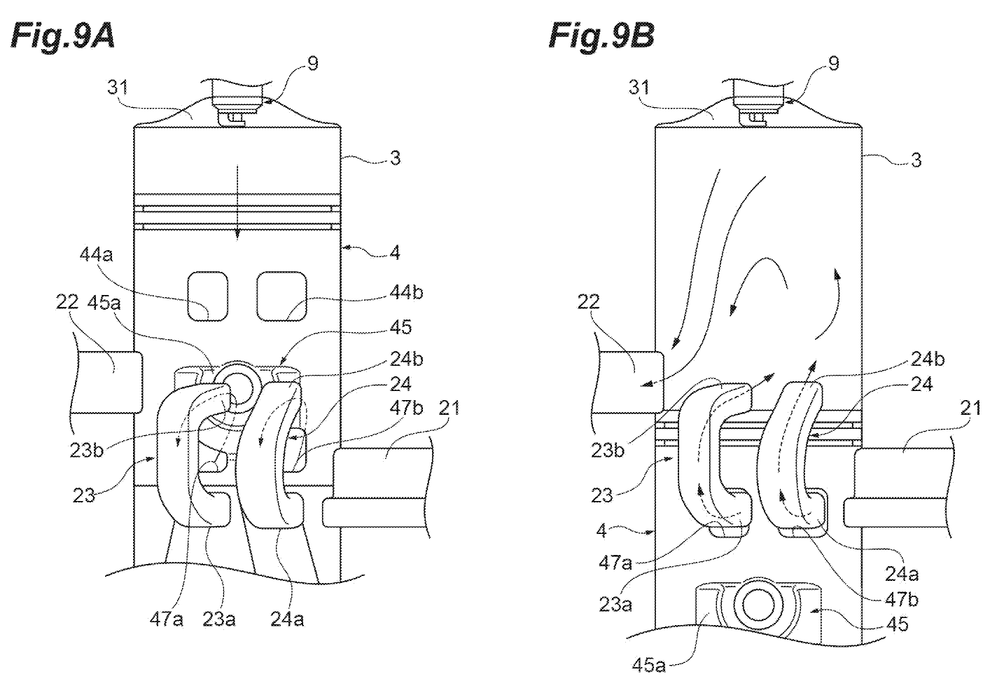

Due to the explosion of the mixture, as shown in FIG. 9A, the piston 4 descends from the top dead center toward the bottom dead center, and the intake port 21 is closed by the piston 4. Due to the descent of the piston 4, the mixture in the second region R2 and the crank chamber 51 is pressurized. As shown in FIG. 9B, when the descent of the piston 4 further proceeds, the exhaust port 22 is opened, and the combustion gas in the first region R1 is exhausted. Then, slightly delayed from the opening of the exhaust port 22, the scavenging outlet 23b of the scavenging passage 23 is opened. The scavenging inlet 23a of the scavenging passage 23 communicates with the piston scavenging hole 44a provided in the piston 4. Therefore, the first region R1 and the second region R2 communicate with each other via the scavenging passage 23. Therefore, the mixture in the second region R2 of the cylinder bore 3 and the crank chamber 51 is sent to the first region R1 of the cylinder bore 3 between the combustion chamber 31 and the piston head 41 via the scavenging passage 23, and the scavenging stroke is started. The scavenging passages 24 to 26 also send the mixture to the first region R1 in the scavenging stroke, similarly to the scavenging passage 23.

When the piston 4 reaches the bottom dead center, the piston 4 starts moving toward the top dead center and returns to the state shown in FIG. 8A.

As described above, in the engine 1, air is introduced from the intake port 21 into the second region R2 of the cylinder bore 3 and the crank chamber 51 connected to the cylinder bore 3 in the intake stroke shown in FIG. 2. Since fuel is injected toward the crank chamber 51 by the injector 8, the second region R2 maintains the state of the air introduced from the intake port 21, so the concentration of fuel in the second region R2 is low, and the inner space of the crank chamber 51 is in a state where the concentration of fuel is high. That is, in the crank chamber 51 and the second region R2, the concentration of fuel in the gas decreases from the crank chamber 51 toward the second region R2. Then, in this engine 1, in the scavenging stroke shown in FIG. 5, the two spaces (the first region R1 and the second region R2) in the cylinder bore 3 partitioned by the piston head 41 communicate with each other via the scavenging passage 23. Since the scavenging inlet 23a of the scavenging passage 23 opens on the bore inner peripheral surface 3a of the cylinder bore 3, the air (air not mixed with fuel) introduced into the cylinder bore 3 in the intake stroke shown in FIG. 2 can be sent as leading air to the first region R1 of the cylinder bore 3 between the combustion chamber 31 and the piston head 41 via the scavenging passage 23, and thereafter the mixture held in the crank chamber 51 can be sent. The scavenging passages 24 to 26 also have the same configuration as the scavenging passage 23. Therefore, the engine 1 can perform scavenging in the first region R1 with the air (leading air) introduced from the intake port 21, and can reduce the escape of the mixture from the exhaust port 22 in the scavenging stroke. Thus, the engine 1 can further reduce the blow-by of the mixture.

The intake port 21 and the scavenging inlet 23a of the scavenging passage 23 are provided at positions where at least parts thereof overlap each other in the direction of the axis L. Both the intake port 21 and the scavenging inlet 23a are located on an annular imaginary line L1 (see FIG. 3) extending in a circumferential direction (D2) of the cylinder 2. The intake port 21 includes a first portion 21x located on the imaginary line L1, and a second portion 21y extending continuously from the first portion 21x toward the end wall 2b of the cylinder 2. For this reason, the engine 1 can supply the introduced air to the vicinity of the scavenging inlet 23a of the scavenging passage 23 while suppressing the air introduced into the second region R2 from the intake port 21 from mixing with fuel in the intake stroke. The scavenging passages 24 to 26 also have the same configuration as the scavenging passage 23. Therefore, the engine 1 can send air with less fuel mixing as leading air to the first region R1 in the scavenging stroke, and can further reduce the blow-by of the mixture.

The piston skirt 42 of the piston 4 is provided with the piston scavenging hole 44a communicating with the scavenging inlet 23a of the scavenging passage 23 in the scavenging stroke. In this case, the engine 1 can send air inside the piston 4 at a location further away from the crank chamber 51 to which fuel is supplied, to the first region R1 via the piston scavenging hole 44a and the scavenging passage 23 in the scavenging stroke. Similarly to the piston scavenging hole 44a, the piston skirt 42 is provided with piston scavenging holes 44b to 44d communicating with the scavenging inlets 24a to 26a of the scavenging passages 24 to 26, respectively. As described above, the concentration of fuel in the second region R2 decreases as the distance from the crank chamber 51 increases. Therefore, the engine 1 can send air with less fuel mixing as leading air to the first region R1 in the scavenging stroke, and can further reduce the blow-by of the mixture.

The piston scavenging hole 44a provided in the piston skirt 42 is located at a position closer to the piston head 41 than the piston pin 43. In this case, the engine 1 can send air inside the piston 4 at a location even further away from the crank chamber 51 to which fuel is supplied, to the first region R1 via the piston scavenging hole 44a and the scavenging passage 23 in the scavenging stroke. The piston scavenging holes 44b to 44d provided in the piston skirt 42 also have the same configuration as the piston scavenging hole 44a. Therefore, the engine 1 can send air with even less fuel mixing as leading air to the first region R1 in the scavenging stroke, and can further reduce the blow-by of the mixture.

The piston skirt 42 is provided with the piston intake hole 47a communicating with the scavenging outlet 23b of the scavenging passage 23 in the intake stroke. Here, in the engine 1, by performing scavenging via the scavenging passage 23, the mixture passing after the leading air may remain in the scavenging passage 23. If the next scavenging stroke is performed with the mixture remaining in the scavenging passage 23, the mixture remaining in the scavenging passage 23 is sent as leading gas to the first region R1, and it may occur that the blow-by of the mixture cannot be reduced. Therefore, in this engine 1, the scavenging outlet 23b of the scavenging passage 23 is made to communicate with the piston intake hole 47a in the intake stroke. As the piston 4 moves toward the top dead center in the intake stroke, the inner space of the piston 4 becomes negative pressure (pressure decreases). For this reason, the engine 1 can suck the mixture remaining in the scavenging passage 23 into the piston 4 by establishing communication between the scavenging outlet 23b of the scavenging passage 23 and the piston intake hole 47a. Then, the engine 1 can fill the scavenging passage 23 with the air introduced from the intake port 21 via the scavenging inlet 23a of the scavenging passage 23. Therefore, when performing the next scavenging stroke, the engine 1 can send the air introduced from the intake port 21 as leading air to the first region R1. Similarly to the piston intake hole 47a, the piston skirt 42 is provided with piston intake holes 47b to 47d communicating with the scavenging outlets 24b to 26b of the scavenging passages 24 to 26, respectively. Therefore, the engine 1 can further reduce the blow-by of the mixture.

The piston recess 45 is provided on the outer surface 42a of the piston skirt 42. The piston intake hole 47a is provided in a part of the piston recess 45. The piston recess 45 faces the scavenging outlet 23b of the scavenging passage 23 in the intake stroke. In this engine 1, when the scavenging outlet 23b of the scavenging passage 23 and the piston recess 45 face each other, the scavenging outlet 23b of the scavenging passage 23 is open. The piston intake hole 47a is provided in a part of the bottom portion 45a of the piston recess 45. That is, the piston recess 45 is larger than the piston intake hole 47a. Even in a state where the scavenging outlet 23b of the scavenging passage 23 faces the piston recess 45, the scavenging outlet 23b of the scavenging passage 23 communicates with the space inside the piston 4 via the piston recess 45 and the piston intake hole 47a. Therefore, in the engine 1, in the intake stroke, not only at the timing when the scavenging outlet 23b of the scavenging passage 23 and the piston intake hole 47a face each other, but also if the scavenging outlet 23b of the scavenging passage 23 and the piston recess 45 face each other, the scavenging passage 23 and the inner space of the piston 4 can communicate with each other. Therefore, the engine 1 sucks the mixture remaining in the scavenging passage 23 into the piston 4 in the intake stroke, and can secure a longer time for filling the scavenging passage 23 with air. Thus, the engine 1 can more reliably remove the mixture remaining in the scavenging passage 23, and can send air containing no (or less) fuel as leading air to the first region R1 in the next scavenging stroke.

The piston recess 45 faces the scavenging outlet 24b of the scavenging passage 24 in the intake stroke. The piston intake hole 47b is provided in the piston recess 45. The piston recess 46 having the same configuration as the piston recess 45 is provided on the outer surface 42a of the piston skirt 42. The piston recess 46 faces the scavenging outlets 25b and 26b of the scavenging passages 25 and 26 in the intake stroke. The piston intake holes 47c and 47d are provided in the piston recess 46. For this reason, similarly to the scavenging passage 23, the engine 1 can suck the mixture remaining in the scavenging passages 24 to 26 in the intake stroke and fill the inner spaces of the scavenging passages 24 to 26 with air.

The engine working machine 100 includes the above engine 1 as a power source. In this case, the engine working machine 100 can operate using the engine 1 capable of further reducing the blow-by of the mixture as a power source.

It is to be understood that not all aspects, advantages and features described herein may necessarily be achieved by, or included in, any one particular example. Indeed, having described and illustrated various examples herein, it should be apparent that other examples may be modified in arrangement and detail.

For example, the piston intake hole 47a may have a notch shape formed by cutting out the lower end portion of the piston skirt 42. Similarly, each of the piston intake holes 47b to 47d may also have a notch shape. Even in this case, the engine 1 can suck the mixture remaining in the scavenging passages 23 to 26 into the piston 4 via the piston intake holes having a notch shape. Instead of the piston intake hole 47a, a groove-shaped piston intake groove provided on the outer surface 42a of the piston skirt 42 and extending to the lower end portion of the piston skirt 42 may be used. Similarly to the piston intake hole 47a, groove-shaped piston intake grooves may be used instead of the piston intake holes 47b to 47d.

The number of scavenging passages provided in the engine 1 is not limited to four. The scavenging passage 23 may be constituted by a groove provided on the bore inner peripheral surface 3a of the cylinder bore 3 and the outer surface 42a of the piston 4. Similarly, the scavenging passages 24 to 26 may also be constituted by grooves provided on the bore inner peripheral surface 3a of the cylinder bore 3 and the outer surface 42a of the piston 4.

An example two-cycle engine (1) may include: a cylinder (2) in which a cylinder bore (3) and a combustion chamber (31) connected to one part of the cylinder bore (3) in a direction of an axis (L) of the cylinder bore (3) are formed; a crankcase (5) disposed on the cylinder (2) and provided with a crank chamber (51) connected to the other part of the cylinder bore (3) in the direction of the axis (L); a piston (4) configured to reciprocate in the cylinder bore (3); and an injector (8) configured to inject fuel into the crank chamber (51). The cylinder (2) may be provided with: an intake port (21) communicating with the cylinder bore (3) and configured to introduce air into the cylinder bore (3); an exhaust port (22) communicating with the cylinder bore (3) and configured to discharge exhaust gas in the cylinder bore (3); and a scavenging passage (23 to 26) configured to send a mixture to a first region (R1) closer to the combustion chamber (31) than a piston head (41) of the piston (4) in the cylinder bore (3) in a scavenging stroke. A scavenging outlet (23b to 26b) and a scavenging inlet (23a to 26a) of the scavenging passage (23 to 26) may open on a bore inner peripheral surface (3a) of the cylinder bore (3), respectively. In the scavenging stroke, the scavenging outlet (23b to 26b) may be located closer to the combustion chamber (31) than a piston head (41) of the piston (4) on the bore inner peripheral surface (3a). In the scavenging stroke, the scavenging inlet (23a to 26a) may be located closer to the crank chamber (51) than the piston head (41) on the bore inner peripheral surface (3a). In the scavenging stroke, the first region (R1) closer to the combustion chamber (31) than the piston head (41) and a second region (R2) closer to the crank chamber (51) than the piston head (41) in the cylinder bore (3) may communicate with each other via the scavenging passage (23 to 26).

In this two-cycle engine (1), air is introduced from the intake port (21) into the second region (R2) and the crank chamber (51) in an intake stroke. Since fuel is injected toward the crank chamber (51) by the injector (8), the second region (R2) maintains the state of the air introduced from the intake port (21), so the concentration of fuel is low, and the inner space of the crank chamber (51) is in a state where the concentration of fuel is high. That is, in the crank chamber (51) and the second region (R2), the concentration of fuel in the gas decreases from the crank chamber (51) toward the second region (R2). Then, in this two-cycle engine (1), in the scavenging stroke, the two spaces (the first region (R1) and the second region (R2)) in the cylinder bore (3) partitioned by the piston head (41) communicate with each other via the scavenging passage (23 to 26). Since the scavenging inlet (23a to 26a) of the scavenging passage (23 to 26) opens on the bore inner peripheral surface (3a) of the cylinder bore (3), the air (air not mixed with fuel) introduced into the second region (R2) in the intake stroke can be sent as leading air to the first region (R1) via the scavenging passage (23 to 26), and thereafter the mixture held in the crank chamber (51) can be sent. Therefore, the two-cycle engine (1) can perform scavenging in the first region (R1) with the air (leading air) introduced from the intake port (21), and can reduce the escape of the mixture from the exhaust port (22) in the scavenging stroke. Thus, the two-cycle engine (1) can further reduce the blow-by of the mixture.

In some examples, the intake port (21) and the scavenging inlet (23a to 26a) of the scavenging passage (23 to 26) may be provided at positions where at least parts thereof overlap each other in the direction of the axis (L).

In this case, the two-cycle engine (1) can supply the introduced air to the vicinity of the scavenging inlet (23a to 26a) of the scavenging passage (23 to 26) while suppressing the air introduced into the second region (R2) from the intake port (21) from mixing with fuel in the intake stroke. Therefore, the two-cycle engine (1) can send air with less fuel mixing as leading air to the first region (R1)in the scavenging stroke, and can further reduce the blow-by of the mixture.

In some examples, the piston (4) may include a piston skirt (42) extending from an outer edge portion of the piston head (41). The piston skirt (42) may be provided with a piston scavenging hole (44a to 44d) communicating with the scavenging inlet (23a to 26a) of the scavenging passage (23 to 26) in the scavenging stroke.

In this case, the two-cycle engine (1) can send air inside the piston (4) located at a place further away from the crank chamber (51) to which fuel is supplied, to the first region (R1)via the piston scavenging hole (44a to 44d) and the scavenging passage (23 to 26) in the scavenging stroke. As described above, the concentration of fuel in the second region (R2) decreases as the distance from the crank chamber (51) increases. Therefore, the two-cycle engine (1) can send air with less fuel mixing as leading air to the first region (R1)in the scavenging stroke, and can further reduce the blow-by of the mixture.

In some examples, the piston scavenging hole (44a to 44d) may be provided in the piston skirt (42) at a position closer to the piston head (41) than a piston pin (43) connecting the piston (4) and a connecting rod (7).

In this case, the two-cycle engine (1) can send air inside the piston (4) located at a place even further away from the crank chamber (51) to which fuel is supplied, to the first region (R1) via the piston scavenging hole (44a to 44d) and the scavenging passage (23 to 26) in the scavenging stroke. Therefore, the two-cycle engine (1) can send air with even less fuel mixing as leading air to the first region (R1)in the scavenging stroke, and can further reduce the blow-by of the mixture.

In some examples, the piston skirt (42) may be provided with a piston intake hole (47a to 47d) connecting with the scavenging outlet (23b to 26b) of the scavenging passage (23 to 26) in an intake stroke of introducing air from the intake port (21) into the cylinder bore (3).

Here, in the two-cycle engine (1), by performing scavenging via the scavenging passage (23 to 26), the mixture passing after the leading air may remain in the scavenging passage (23 to 26). If the next scavenging stroke is performed with the mixture remaining in the scavenging passage (23 to 26), the mixture remaining in the scavenging passage (23 to 26) is sent as leading gas to the first region (R1), and it may occur that the blow-by of the mixture cannot be reduced. Therefore, in this two-cycle engine (1), the scavenging outlet (23b to 26b) of the scavenging passage (23 to 26) is made to communicate with the piston intake hole (47a to 47d) in the intake stroke. As the piston (4) moves toward the top dead center in the intake stroke, the inner space of the piston (4) becomes negative pressure (pressure decreases). For this reason, the two-cycle engine (1) can suck the mixture remaining in the scavenging passage (23 to 26) into the piston (4) by making the scavenging outlet (23b to 26b) of the scavenging passage (23 to 26) communicate with the piston intake hole (47a to 47d). Then, the two-cycle engine (1) can fill the scavenging passage (23 to 26) with the air introduced from the intake port (21) via the scavenging inlet (23a to 26a) of the scavenging passage (23 to 26). Therefore, when performing the next scavenging stroke, the two-cycle engine (1) can send the air introduced from the intake port (21) as leading air to the first region (R1)in the cylinder bore (3). Thus, the two-cycle engine (1) can further reduce the blow-by of the mixture.

In some examples, a piston recess (45, 46) may be provided on an outer surface (42a) of the piston skirt (42). The piston intake hole (47a to 47d) may be provided in a part of a bottom portion (45a, 46a) of the piston recess (45, 46). The piston recess (45, 46) may face the scavenging outlet (23b to 26b) of the scavenging passage (23 to 26) in the intake stroke.

In this two-cycle engine (1), when the scavenging outlet (23b to 26b) of the scavenging passage (23 to 26) and the piston recess (45, 46) face each other, the scavenging outlet (23b to 26b) of the scavenging passage (23 to 26) is open. The piston intake hole (47a to 47d) is provided in a part of the bottom portion (45a, 46a) of the piston recess (45, 46). That is, the piston recess (45, 46) is larger than the piston intake hole (47a to 47d). Even in a state where the scavenging outlet (23b to 26b) of the scavenging passage (23 to 26) faces the piston recess (45, 46), the scavenging outlet (23b to 26b) of the scavenging passage (23 to 26) communicates with the space inside the piston (4) via the piston recess (45, 46) and the piston intake hole (47a to 47d). Therefore, in the two-cycle engine (1), in the intake stroke, not only at the timing when the scavenging outlet (23b to 26b) of the scavenging passage (23 to 26) and the piston intake hole (47a to 47d) face each other, but also when the scavenging outlet (23b to 26b) of the scavenging passage (23 to 26) and the piston recess (45, 46) face each other, the scavenging passage (23 to 26) and the inner space of the piston (4) can communicate with each other. Thus, the two-cycle engine (1) sucks the mixture remaining in the scavenging passage (23 to 26) into the piston (4) in the intake stroke, and can secure a longer time for filling the scavenging passage (23 to 26) with air. Accordingly, the two-cycle engine (1) can more reliably remove the mixture remaining in the scavenging passage (23 to 26), and can send air containing no (or less) fuel as leading air to the combustion chamber (31) in the next scavenging stroke.

In some examples, the piston intake hole (47a to 47d) may have a notch shape formed by cutting out an end portion of the piston skirt (42).

Even in this case, the two-cycle engine (1) can suck the mixture remaining in the scavenging passage (23 to 26) into the piston (4) via the piston intake hole (47a to 47d) having a notch shape.

An example engine working machine (100) may include the two-cycle engine (1) described above as a power source.

In this case, the engine working machine (100) can operate using the two-cycle engine (1) capable of further reducing the blow-by of the mixture as a power source.

An example two-cycle engine (1) may include: a cylinder (2) extending in an axial direction (D1); a piston (4) configured to reciprocate in the cylinder (2) in the axial direction (D1) of the cylinder (2); and a scavenging passage (23). The cylinder (2) may include a first opening (23a) and a second opening (23b) in fluid communication with and spaced apart from the first opening (23a) in the axial direction (D1) of the cylinder (2). One end of the scavenging passage (23) may be connected to the first opening (23a). An opposite end of the scavenging passage (23) may be connected to the second opening (23b). A piston head (41) of the piston (4) may be located between the first opening (23a) and the second opening (23b) in the axial direction (D1) of the cylinder (2) when the piston (4) is located at a bottom dead center.

In some examples, the second opening (23b) may be located closer to an end wall (2b) of the cylinder (2) than the first opening (23a) in the axial direction (D1) of the cylinder (2).

In some examples, when the piston (4) is located at the bottom dead center, a first space (R1) in the cylinder (2) between the end wall (2b) of the cylinder (2) and the piston head (41) may communicate with the scavenging passage (23) through the second opening (23b). A second space (R2) in the cylinder (2) between the piston head (41) and an open end of the cylinder (2) may communicate with the scavenging passage (23) through the first opening (23a) when the piston (4) is located at the bottom dead center.

In some examples, the cylinder (2) may further include an intake port (21) configured to introduce air into the cylinder bore (3). Both the intake port (21) and the first opening (23a) may be located on an annular imaginary line extending in a circumferential direction (D2) of the cylinder (2).

In some examples, the intake port may include: a first portion located on the imaginary line; and a second portion extending from the first portion toward the end wall of the cylinder.

In some examples, the piston (4) may include a piston skirt (42) extending from an outer edge portion of the piston head (41) toward an open end of the cylinder (2). The piston skirt (42) may include a piston scavenging hole (44a) communicating with the first opening (23a) when the piston (4) is located at the bottom dead center.

In some examples, the piston (4) may include a piston pin (43) located inside the piston skirt (42). A connecting rod (7) may be connected to one end of the piston pin (43). The piston scavenging hole (44a) may be located between the piston head (41) and the piston pin (43).

In some examples, the piston (4) may include a piston skirt (42) extending from an outer edge portion of the piston head (41) toward the open end of the cylinder (2). The piston skirt (42) may include a piston intake hole (47a) communicating with the second opening (23b) when the piston (4) is located at a top dead center.

In some examples, the piston intake hole (47a) may extend through a piston recess (45) provided on an outer surface (42a) of the piston skirt (42).

In some examples, the piston (4) may include a piston skirt (42) extending from an outer edge portion of the piston head (41) toward an open end of the cylinder (2). The piston skirt (42) may include a notch portion facing the second opening (23b) when the piston (4) is located at a top dead center.

In some examples, the cylinder (2) may further include: an intake port (21) configured to introduce air into the cylinder bore (3); and an exhaust port (22) configured to discharge exhaust gas from the cylinder bore (3). The exhaust port (22) may be located at a position closer to an end wall (2b) of the cylinder (2) than the intake port (21) in the axial direction (D1) of the cylinder (2).

An example two-cycle engine (1) may further include a spark plug (9) attached to an end wall (2b) of the cylinder (2). The end wall (2b) of the cylinder (2) may include a combustion chamber (31) recessed in a direction away from the piston (4). The spark plug (9) may be configured to ignite a mixture in the combustion chamber (31) to combust the mixture when the piston (4) is located in a vicinity of a top dead center.

What is claimed is:

1. A two-cycle engine comprising:
a cylinder including a cylinder bore and a combustion chamber connected to one end of the cylinder bore in an axial direction of the cylinder bore;
a crankcase disposed on the cylinder and provided with a crank chamber connected to an opposite end of the cylinder bore in the axial direction;
a piston configured to reciprocate in the cylinder bore; and
an injector configured to inject fuel into the crank chamber,
wherein the cylinder is provided with:
an intake port communicating with the cylinder bore and configured to introduce air into the cylinder bore;
an exhaust port communicating with the cylinder bore and configured to discharge exhaust gas from the cylinder bore; and
a scavenging passage configured to send a mixture to a first region closer to the combustion chamber than a piston head of the piston in the cylinder bore in a scavenging stroke,
wherein a scavenging outlet and a scavenging inlet of the scavenging passage open on a bore inner peripheral surface of the cylinder bore, respectively, and
wherein, in the scavenging stroke, the scavenging outlet is located closer to the combustion chamber than a piston head of the piston on the bore inner peripheral surface, the scavenging inlet is located closer to the crank chamber than the piston head on the bore inner peripheral surface, and the first region and a second region closer to the crank chamber than the piston head in the cylinder bore communicate with each other via the scavenging passage.

2. The two-cycle engine according to claim 1, wherein the intake port and the scavenging inlet of the scavenging passage are provided at positions where at least parts thereof overlap each other in the axial direction of the cylinder.

3. The two-cycle engine according to claim 1,
wherein the piston includes a piston skirt extending from an outer edge portion of the piston head, and
wherein the piston skirt is provided with a piston scavenging hole communicating with the scavenging inlet of the scavenging passage in the scavenging stroke.

4. The two-cycle engine according to claim 3, wherein the piston scavenging hole is provided in the piston skirt at a position closer to the piston head than a piston pin connecting the piston and a connecting rod.

5. The two-cycle engine according to claim 3, wherein the piston skirt is provided with a piston intake hole communicating with the scavenging outlet of the scavenging passage in an intake stroke of introducing air from the intake port into the cylinder bore.

6. The two-cycle engine according to claim 5,
wherein a piston recess is provided on an outer surface of the piston skirt,
wherein the piston intake hole is provided in a bottom portion of the piston recess, and
wherein the piston recess faces the scavenging outlet of the scavenging passage in the intake stroke.

7. The two-cycle engine according to claim 5, wherein the piston intake hole has a notch shape formed by cutting out an end portion of the piston skirt.

8. An engine working machine comprising the two-cycle engine according to claim 1 as a power source.

9. A two-cycle engine comprising:
a cylinder extending in an axial direction;
a piston configured to reciprocate in the cylinder in the axial direction of the cylinder; and
a scavenging passage,
wherein the cylinder includes a first opening and a second opening in fluid communication with and spaced apart from the first opening in the axial direction of the cylinder,
wherein one end of the scavenging passage is connected to the first opening,
wherein an opposite end of the scavenging passage is connected to the second opening, and
wherein, when the piston is located at a bottom dead center, a piston head of the piston is located between the first opening and the second opening in the axial direction of the cylinder.

10. The two-cycle engine according to claim 9, wherein the second opening is located closer to an end wall of the cylinder than the first opening in the axial direction of the cylinder.

11. The two-cycle engine according to claim 10,
wherein, when the piston is located at the bottom dead center, a first space in the cylinder between the end wall of the cylinder and the piston head communicates with the scavenging passage through the second opening, and
wherein, when the piston is located at the bottom dead center, a second space in the cylinder between the piston head and an open end of the cylinder communicates with the scavenging passage through the first opening.

12. The two-cycle engine according to claim 10,
wherein the cylinder further includes an intake port configured to introduce air into an internal space of the cylinder, and
wherein both the intake port and the first opening are located on an annular imaginary line extending in a circumferential direction of the cylinder.

13. The two-cycle engine according to claim 12, wherein the intake port includes:
a first portion located on the imaginary line; and
a second portion extending from the first portion toward the end wall of the cylinder.

14. The two-cycle engine according to claim 10,
wherein the piston includes a piston skirt extending from an outer edge portion of the piston head toward an open end of the cylinder, and
wherein the piston skirt includes a piston scavenging hole communicating with the first opening when the piston is located at the bottom dead center.

15. The two-cycle engine according to claim 14,
wherein the piston includes a piston pin located inside the piston skirt,
wherein a connecting rod is connected to one end of the piston pin, and
wherein the piston scavenging hole is located between the piston head and the piston pin.

16. The two-cycle engine according to claim 10,
wherein the piston includes a piston skirt extending from an outer edge portion of the piston head toward the open end of the cylinder, and
wherein the piston skirt includes a piston intake hole communicating with the second opening when the piston is located at a top dead center.

17. The two-cycle engine according to claim 16, wherein the piston intake hole extends through a piston recess provided on an outer surface of the piston skirt.

18. The two-cycle engine according to claim 10,
wherein the piston includes a piston skirt extending from an outer edge portion of the piston head toward an open end of the cylinder, and
wherein the piston skirt includes a notch portion facing the second opening when the piston is located at a top dead center.

19. The two-cycle engine according to claim 10,
wherein the cylinder further includes:
an intake port configured to introduce air into an internal space of the cylinder; and
an exhaust port configured to discharge exhaust gas from the internal space of the cylinder, and
wherein the exhaust port is located at a position closer to an end wall of the cylinder than the intake port in the axial direction of the cylinder.

20. The two-cycle engine according to claim 10, further comprising a spark plug attached to an end wall of the cylinder,
wherein the end wall of the cylinder includes a combustion chamber recessed in a direction away from the piston, and
wherein the spark plug is configured to ignite a mixture in the combustion chamber to combust the mixture when the piston is located in a vicinity of a top dead center.
